(19) United States
(12) Patent Application Publication
(10) Pub. No.: US 2016/0110502 A1
(43) Pub. Date: Apr. 21, 2016

(54) Human and Machine Assisted Data Curation for Producing High Quality Data Sets from Medical Records

(71) Applicant: Betterpath, Inc., New York, NY (US)

(72) Inventors: Jonathan Bronson, New York, NY (US); Stacy Banerjee, Cleveland, OH (US); Brett Collinson, New York, NY (US); Robert Goldman, New York, NY (US); Nabil Hassein, Brooklyn, NY (US); Amit Khivesara, Clifton, NJ (US); G. Ralph Kuntz, Denville, NJ (US); B. Adam Russell, Danielson, CT (US); Alexandra Sinderbrand, New York, NY (US); Gary Mark Sinderbrand, Linwood, NJ (US); Matthew Sinderbrand, Brooklyn, NY (US)

(21) Appl. No.: 14/517,044

(22) Filed: Oct. 17, 2014

(51) Int. Cl. G06F 19/00; G06Q 50/00; G06N 99/00

(52) U.S. Cl. CPC G06F 19/322; G06F 19/363; G06F 19/3443; G06N 99/005; G06Q 50/01

(57) ABSTRACT

A method for building a Patient's Data Set from a Patient's Data File to provide robust patient care comprising the steps of obtaining a Patient's Data File, building a training set for machine learning through experts' selection of at least one desired feature from the Patient's Data File to create the Patient's Data Set, developing a data mining algorithm to automate extraction of at least one data feature from at least one other Patient's Data File using the training set, the algorithm automatically generating the Patient's Data Set from at least one other Patient's Data File, supplementing the Patient's Data Set with at least one patient input, and analyzing the Patient's Data Set to confirm patient course of treatment.

### FIELD OF THE INVENTION

The present invention is directed to a method and system for the building of data sets from medical records. Specifically, the method and system of the present invention relates to developing an algorithm to extract information from medical records, patient/caregiver surveys and information input by the patient to build a dataset, and analyzing that data set in real tithe to provide robust patient care.

### BACKGROUND OF THE INVENTION

The automation of extracting information from medical records is well known in the art. For example, U.S. Pat. No. 7,840,512 discloses methods, systems, and instructions for use of a medical ontology for computer assisted clinical decision support. Medical ontology information is used for mining and/or probabilistic modeling. A domain knowledge base may be automatically or semi-automatically created by a processor from a medical ontology. The domain knowledge base, such as a list of disease-associated terms or other medical concepts or terms, is used to mine for corresponding information from a medical record. The relationship of different terms with respect to a disease or concept may be used to train a probabilistic model. A probability of disease or a chance of a term indicating the disease or concept is determined based on the terms from a medical ontology. This probabilistic reasoning is learned with a machine from ontology information and a training data set. However, U.S. Pat. No. '512 does not disclose using finely tuned domain knowledge which is initially coded by hand, and, then, used to develop an algorithm to automate the medical records mining process. These additions to the process can significantly increase the quality of the probabilistic model developed and the resulting insights learned.

U.S. Pat. No. 7,668,372 discloses a method and system for collection of data from documents present in machine-readable form, at least one already processed document stored as a template and designated as a template document is associated with a document to be processed designated as a read document. Fields for data to be extracted are defined in the template document. Data contained in the read document are already extracted from regions that correspond to the fields in the template document. Should an error have occurred or no suitable template document having been associated given the automatic extraction of the data, the read document is shown on a screen and fields are manually inputted in the read document from which the data are extracted. After the manual input of the fields in the read document, the read document with field specifications is stored as a new template document or the previous template document is corrected corresponding to the newly input fields. Unlike the method and system of the present invention, U.S. Pat. No. '372 requires a template format for its extraction. In the method and system of the present invention, the documents to be processed may be in any format.

US 20110191277 discloses a data mining system comprising a planning and learning module which receives as input a knowledge model, which preferably includes a number of data and a set of goals and automatically produces as output a number of plans. The system comprises a data mining processing unit which receives the plans as instructions and automatically produces results which are provided back to the planning and learning module 12 as feedback. Unlike the method and system of the present invention, U.S. Pat. No. '277 utilizes the extracted data to trigger the production of a number of alternative sets of instructions that achieve a proposed input goal, according to different metrics (minimum computation time, maximum accuracy, etc).

U.S. Pat. No. 7,805,385 discloses a system for predicting medical treatment outcomes using a plurality of patient-specific characteristics of a patient. A processor is operable to apply the values to a first prognosis model. The first prognosis model relates a plurality of variables corresponding to the values to a treatment outcome, where the relating is a function of medical knowledge collected from literature and incorporated into the first prognosis model. The method and system of the present invention is not focused on predicting the outcome of a medical treatment. Further, the present invention does not analyze the patient's information or data in view of preferred or accepted treatment plans in an attempt to predict the outcome of the treatment as applied to a specific patient.

WO2004107322 discloses a data extraction and storage process for medical records. However, WO '322 does not disclose the steps of developing an algorithm based on the manual extraction of data, or the analysis of the data for patient care.

Thus, there exists a need for a method and a system which has a finely tuned domain knowledge base derived from initial manual extraction of the medical records, which uses the automated extraction process to extract information from medical records in any format, allows the patient to supplement the database and medical record and, then, analyzes the entire record and database to provide robust and optimal patient care.

### SUMMARY OF THE INVENTION

It is a preferred embodiment of the present invention, there is provided a method for building a data set from a patient's data file to provide robust patient care, the method having the steps of obtaining a patient's data file, building a training set for machine learning through experts' selection of at least one desired feature from the patient's data file to create the data set, developing a data mining algorithm to automate extraction of at least one data feature using the training set, the algorithm automatically generating the data set; supplementing the data set with at least one patient input and analyzing the patient data set to confirm patient course of treatment.

It is an object of the present invention to provide a method wherein the patient course of treatment is modified based on the analysis of the patient's data set.

It is yet another object of the present invention to provide a method wherein the patient's data set is supplemented by a patient's caregiver(s).

It is a further object of the present invention to provide a method wherein the patient input is performed by providing data to a chatbot.

It is also an object of the present invention to provide a system for building a patient's data set from a patient's data file to provide robust patient care, the application capable of performing the steps of reading a document input, extracting at least one data feature from the document using a training set, the training set comprised of at least one desired feature from the patient's data file, at least one desired feature being pre-supplied to the application, the extracted data feature comprising a patient's data set, and, then, analyzing the patient's data set in managed batches or realtime to confirm patient course of treatment.

It is another object of the present invention to provide a system wherein the patient's course of treatment is modified based on the analysis of the patient's data set.

It is a further object of the present invention to provide a system wherein the patient's data set is supplemented with at least one patient input.

It is an additional object of the present invention to provide a system wherein the patient's data set is supplemented by at least one caregiver input.

It is another object of the present invention to provide a system wherein at least one patient input is provided through the use of an interactive chatbot.

### BRIEF DESCRIPTION OF THE DRAWINGS

FIG. 1 is a flow chart of a preferred embodiment of the present invention;

FIG. 2 is a screen interface of a preferred embodiment of the present invention;

FIG. 2A is a screen interface of a preferred embodiment of the present invention;

FIG. 2B is a screen interface of a preferred embodiment of the present invention;

FIG. 2C is a screen interface of a preferred embodiment of the present invention;

FIG. 2D is a screen interface of a preferred embodiment of the present invention;

FIG. 2E is a screen interface of a preferred embodiment of the present invention;

FIG. 2F is a screen interface of a preferred embodiment of the present invention; and

FIG. 3 is a flow chart of another preferred embodiment of the present invention.

### DETAILED DESCRIPTION OF THE INVENTION

One mechanism changing how health and health care is understood and realized is patient-driven health care models, particularly consumer personalized medicine and quantified self-tracking These models support a shift to patient-driven health care, because patients are increasingly beginning to measure and track their symptoms, behavior and environment, both individually and in collaboration with others.

A systemic personalized medicine approach to patient care involves not only the use of an individual's traditionally collected medical data, but includes the additional step of individuals collecting and synthesizing their own data and using it to proactively manage their health.

Quantified self-tracking is the regular collection of any data that can be measured about the self, such as biological, physical, behavioral or environmental information. Health aspects that are not obviously quantitative such as mood can be recorded with qualitative words that can be stored as text or in a tag cloud, mapped to a quantitative scale, or ranked relative to other measures such as yesterday's rating. Many health self-trackers are recording measurements daily or even more frequently.

The present invention is addressed to robust patient care using traditionally collected patient data, self-collected patient data and, optionally, analysis of patient data collected via social media. For the purposes of this application, the terms below are defined as follows:

“Patient's Data File” means the aggregate of traditionally collected patient data and/or self-collected patient data and/or analysis of patient data collected via social media.

“Patient's Data Set” means the aggregate of the extracted desired features from the Patient's Data File.

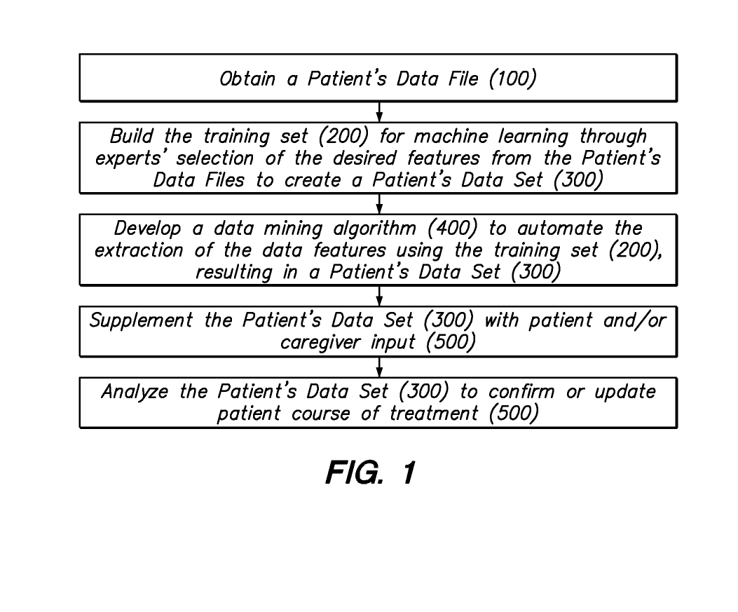

As illustrated in FIG. 1, a preferred embodiment of the method of the present invention is comprised of the following steps, each of which will be discussed in greater detail below.
1. Obtain a Patient's Data File (100) and build the training set (200) for machine learning through experts' selection of the desired features from the Patient's Data File to create a Patient's Data Set (300);
2. Develop a data mining algorithm (400) to automate extraction of the data features using the training set (200) resulting in a curated data set (300);
3. Supplement the Patient's Data Set (300) with patient and/or caregiver input (500); and
4. Analyze the Patient's Data Set (300) to confirm or update patient course of treatment (600).

Step 1. Obtain a Patient's Data File (100) and build the training set for machine learning through experts' selection of the desired features from the Patient's Data File (200).

The first step in the preferred embodiment of the present invention is to obtain a patient's medical record in compliance with State and Federal regulatory and privacy requirements. These records comprise part of the Patient's Data File (100) which will be subjected to data extraction, as outlined in the later steps. A team of medical and scientific experts define a disease-specific “feature set” or “data model”, which will result in comprising the Patient's Data Set (300), of potentially relevant information about a patient's disease, symptoms, genetics, treatments, lifestyle and possibly other information along similar dimensions. Information is chosen based on value to stakeholders including, but not limited to physicians, patients, medical personnel, health administrators, insurance providers and other caregivers. The data are extracted manually using a team of experts (e.g., medical residents, fellows, pharmacists, medical coders). All facts extracted are substantiated by text highlighted by the experts—i.e., the phraseology in the patient information data file is captured so a machine can examine the original phraseology used and establish a causal link, to the features extracted from it, for purposes of automation of extraction of data (200).

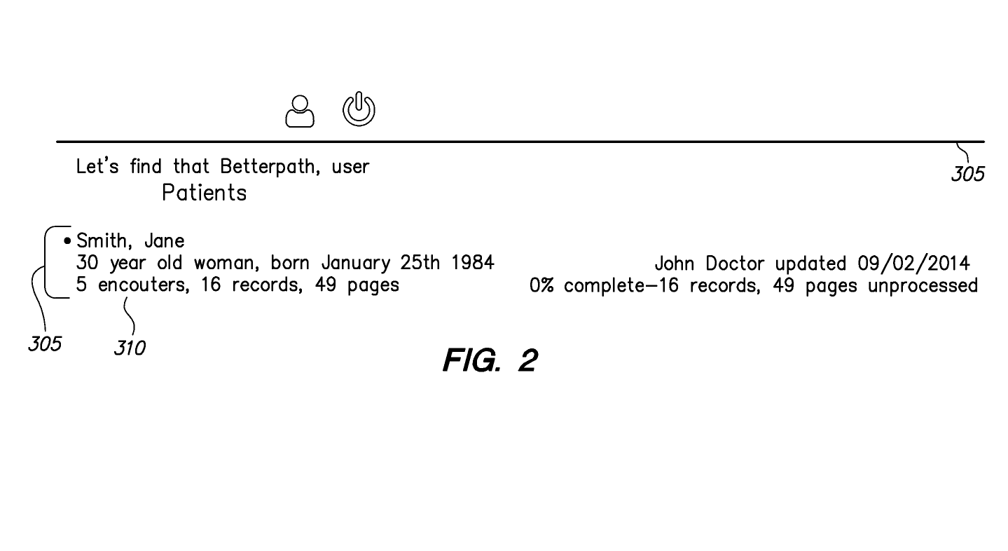

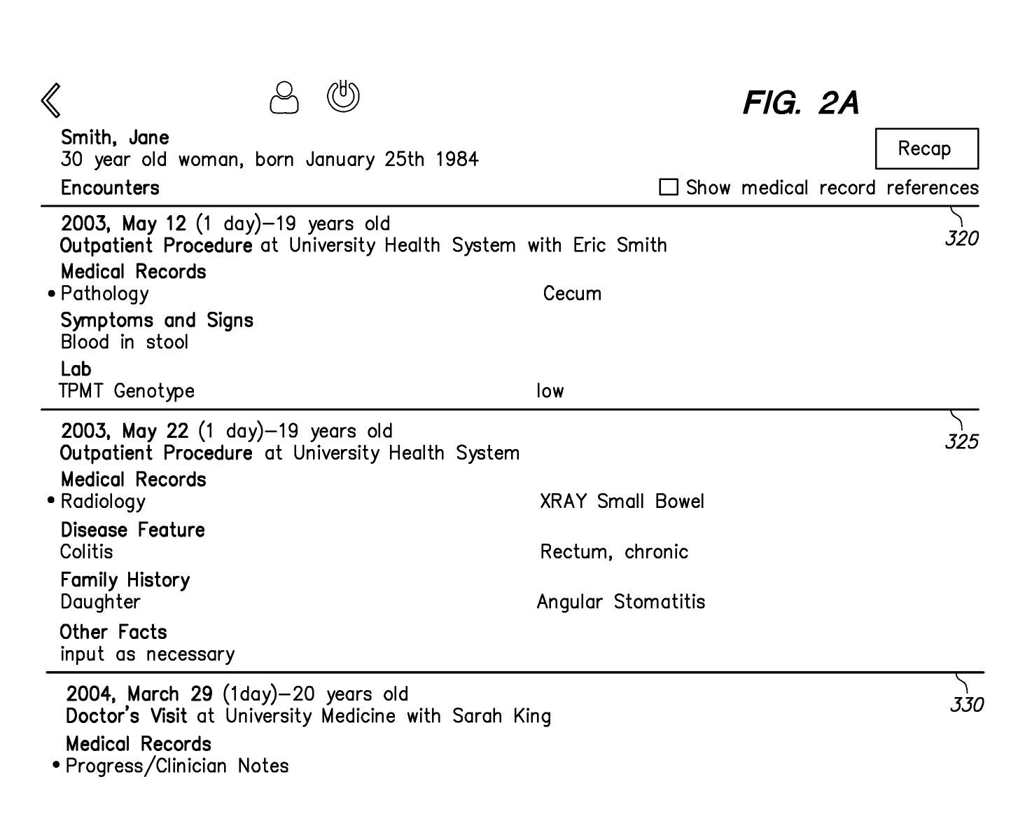

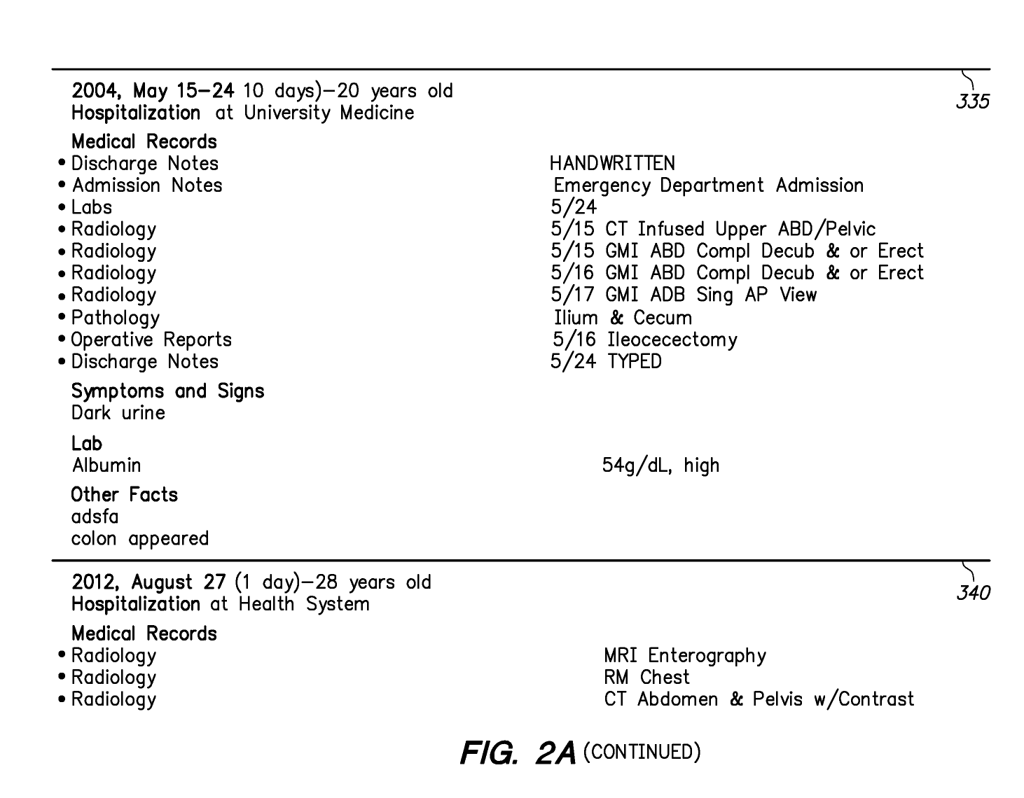

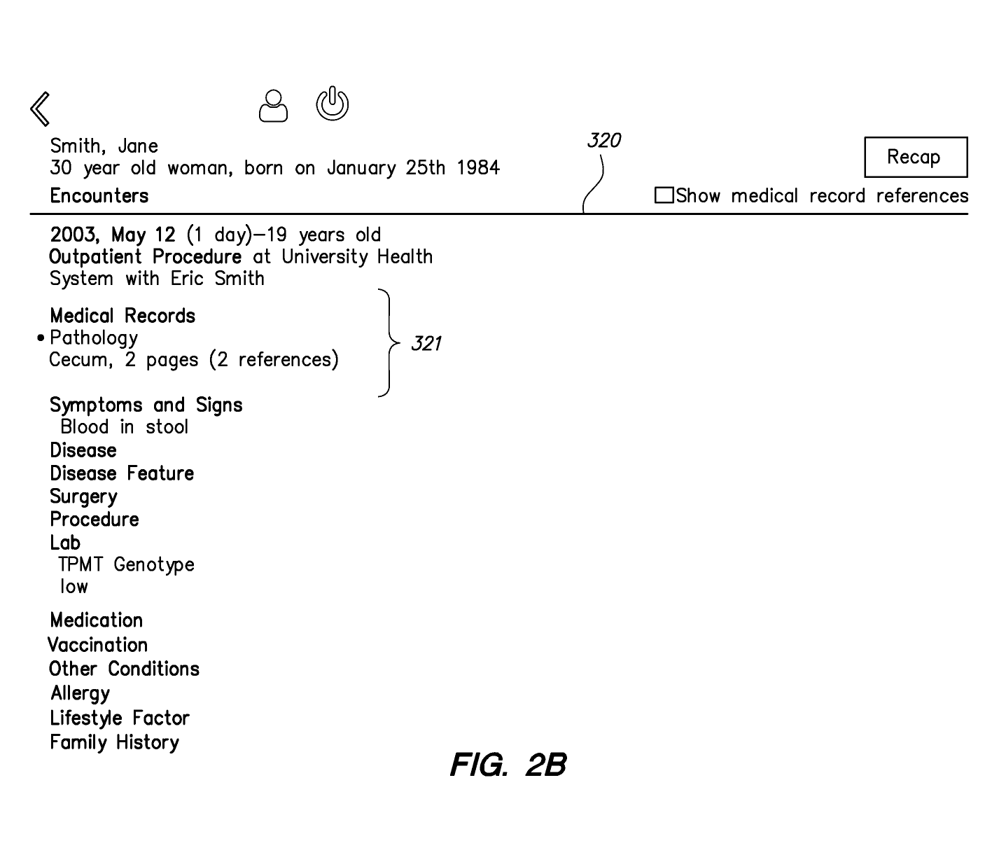

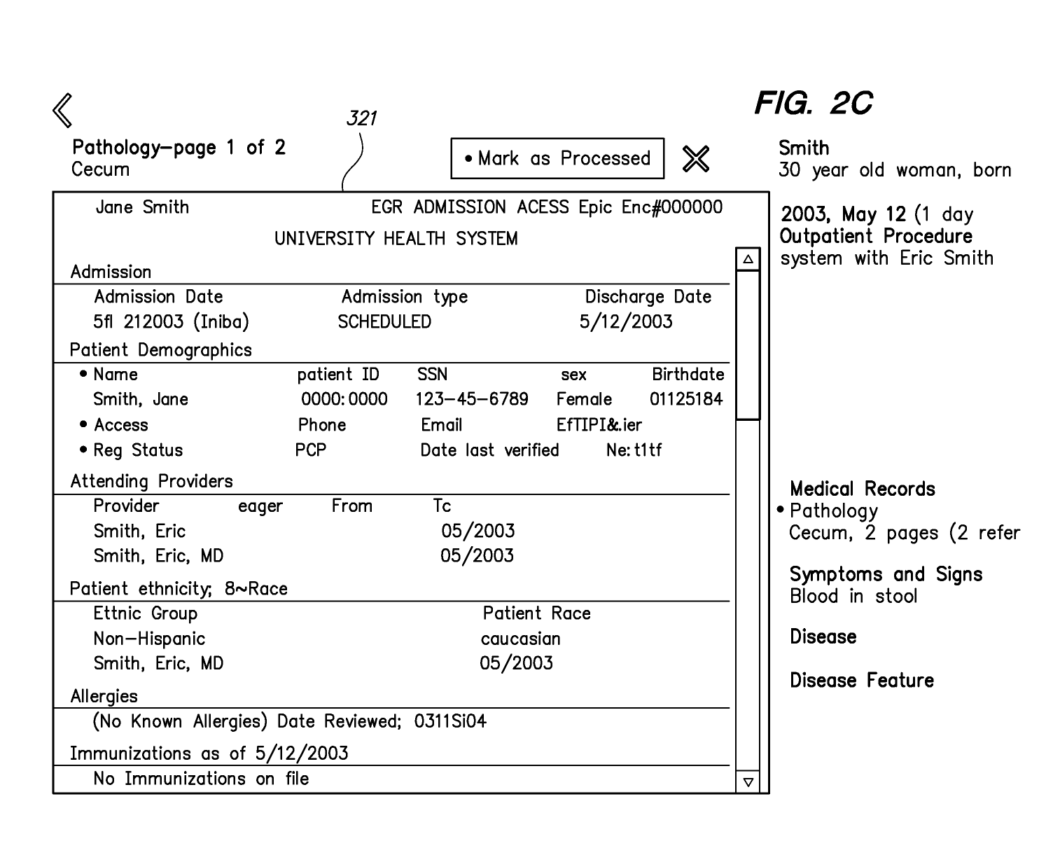

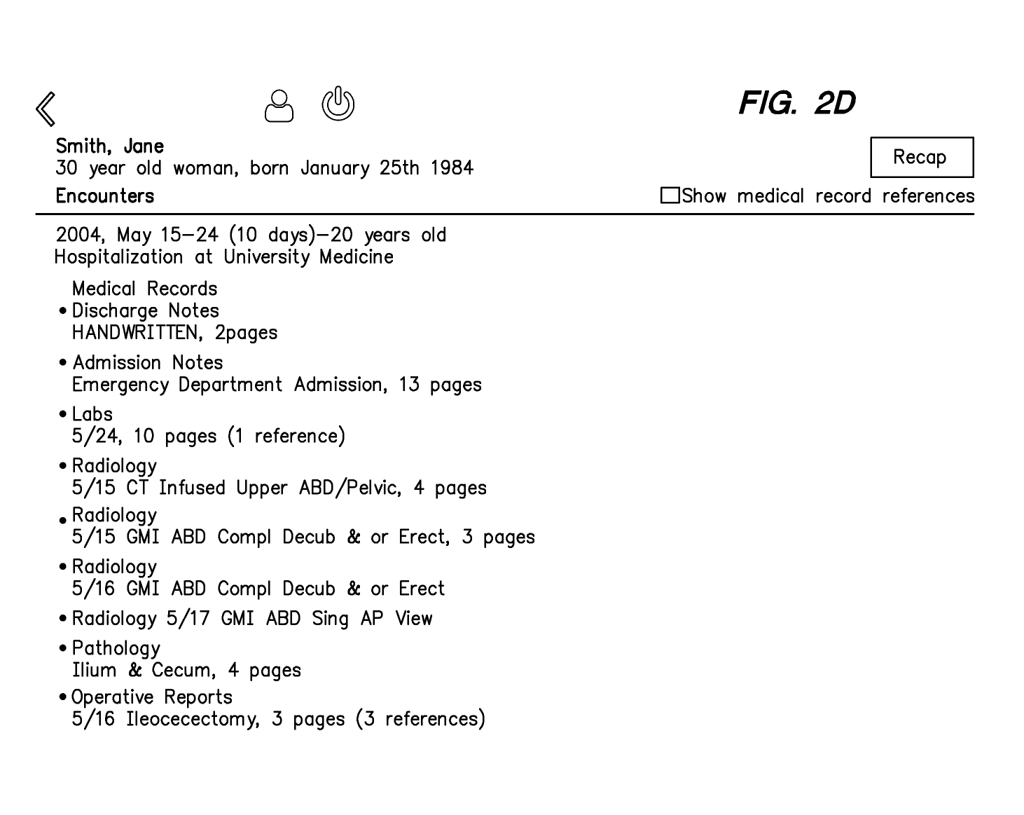

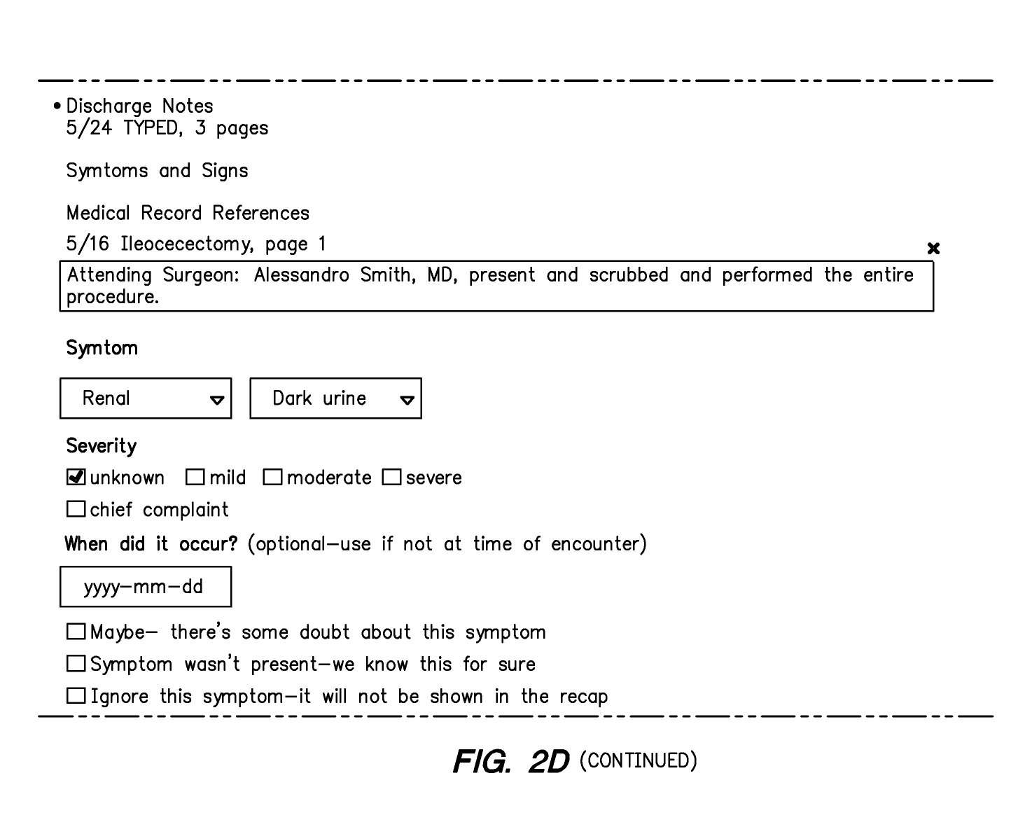

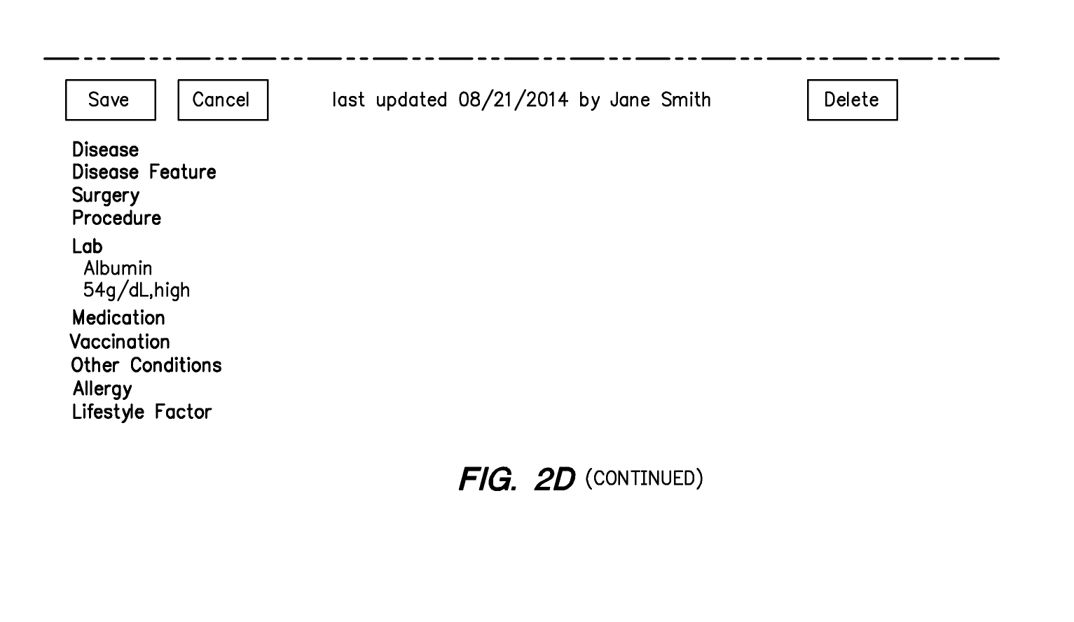

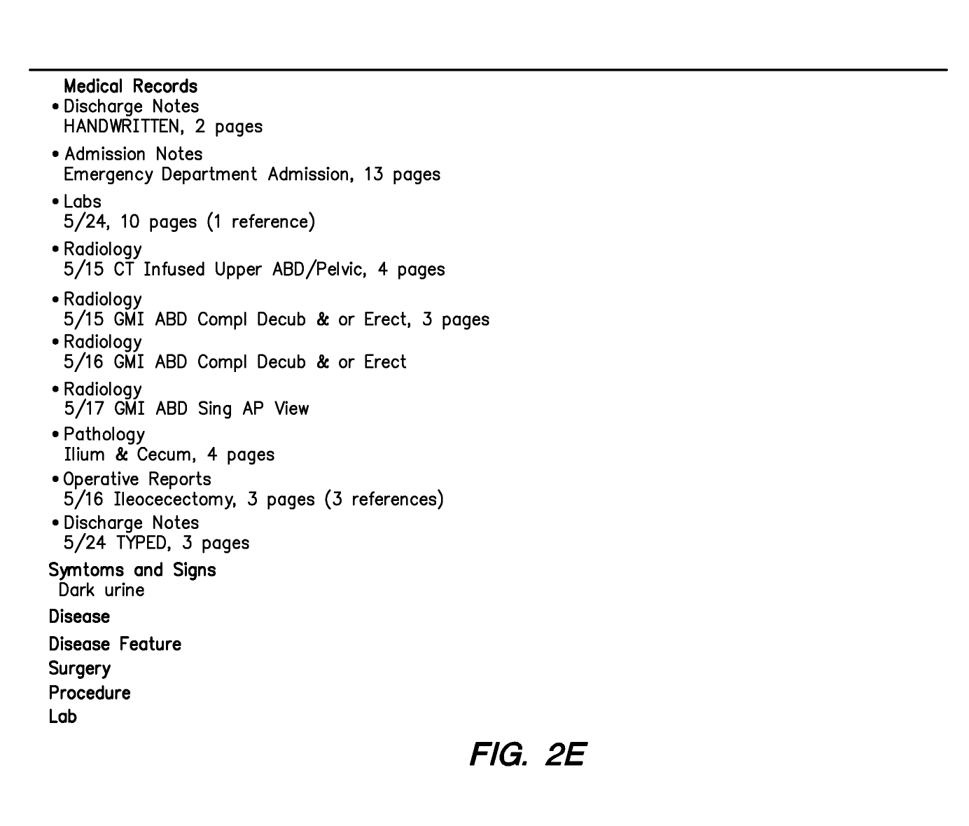

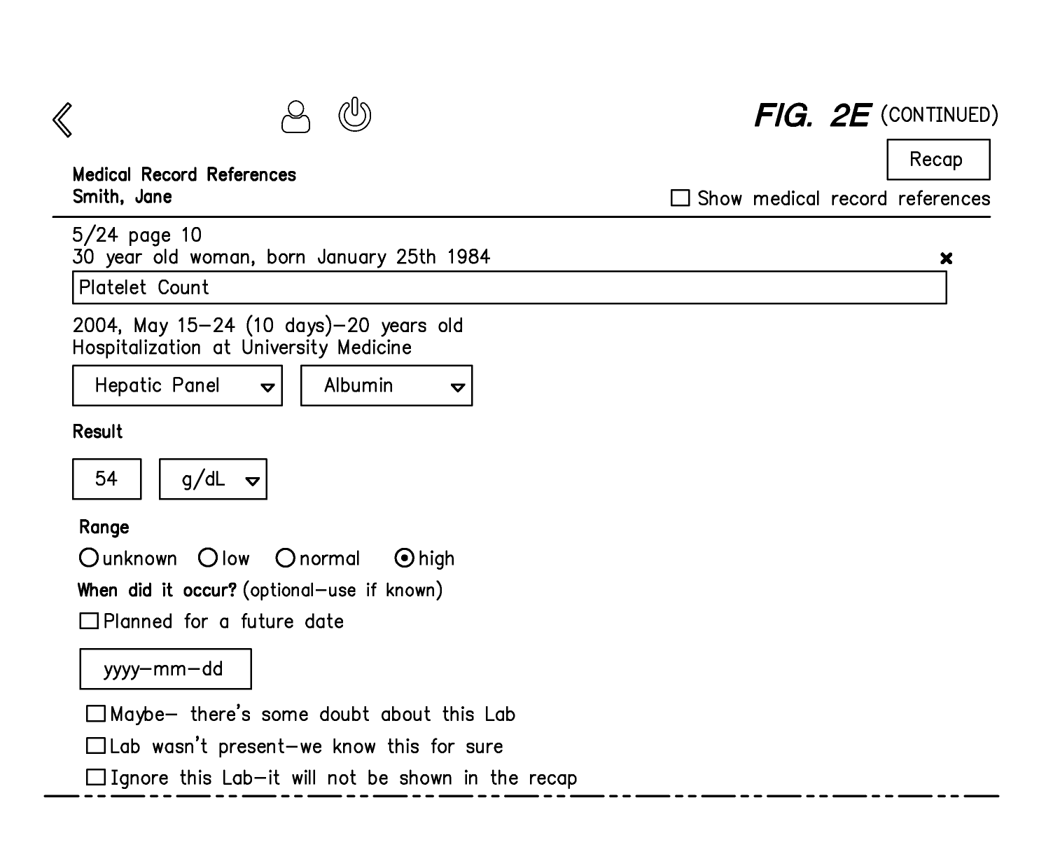

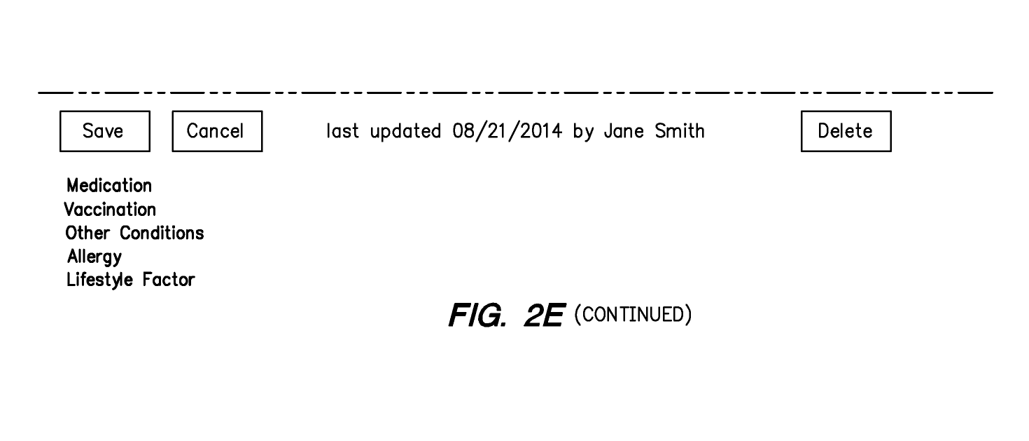

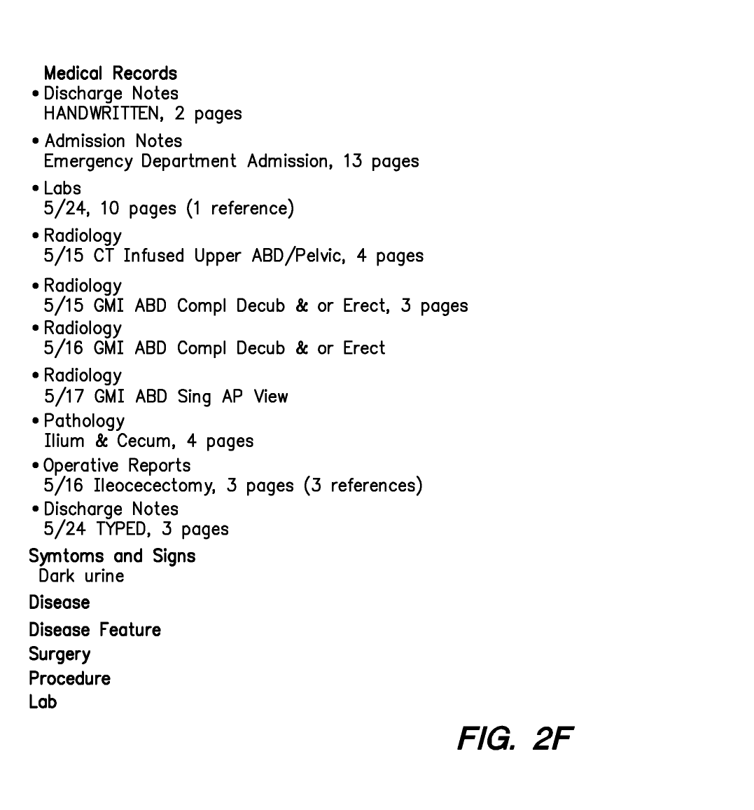

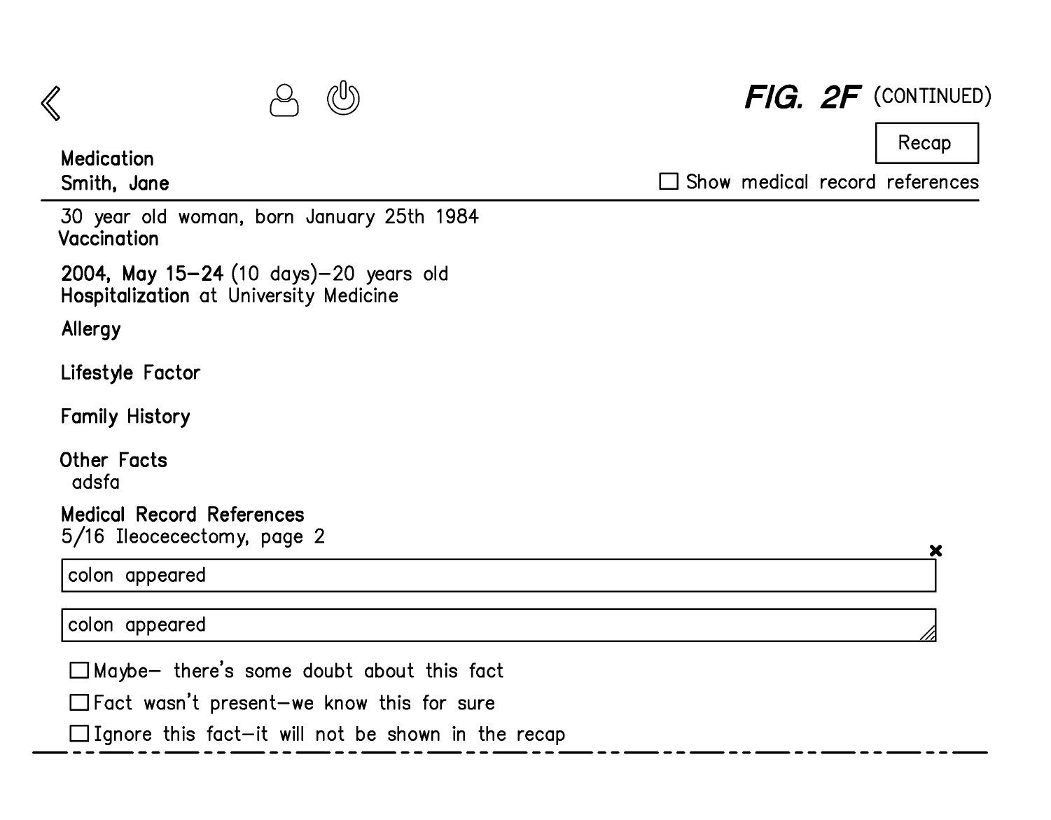

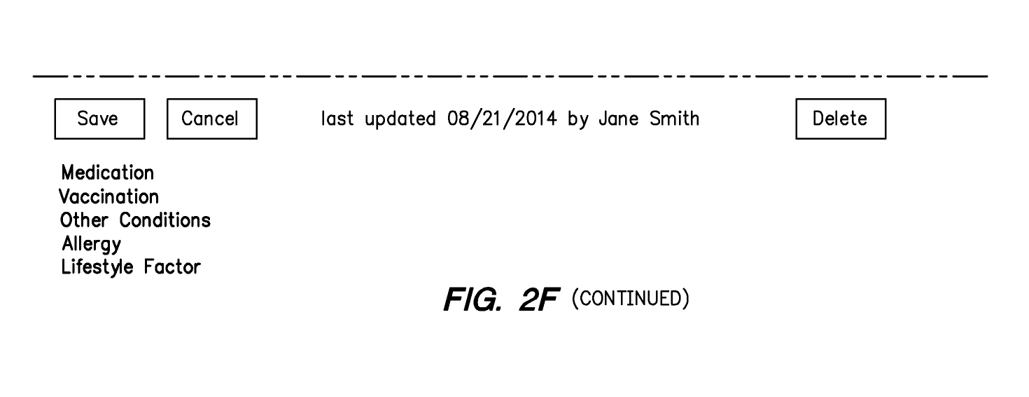

Referring to FIG. 2, Step 1 of the preferred embodiment is demonstrated utilizing an actual Patient's Data Set (305). As can be seen, the summary page lists relevant patient information, such as name, date of birth, number of encounters with medical professionals, and length of and pages in medical record. By clicking on the information bar, a user is directed to the “Encounters” page (310), FIG. 2A. The Encounters page provides a list (315) of all Encounters between the patient and the medical system as obtained from the Patient's Data File (100). In this instance, there are 5 Encounters (320, 325, 330, 335, 340), With reference to FIG. 2B, for the first listed Encounter (320), it can be noted that there are Medical Records—Pathology—(321) for that date for the patient. Referring to FIG. 2C, these actual records (321) are able to be accessed by the user. As can be noted in FIG. 2C, text is highlighted to draw attention to relevant aspects of that record (321). The highlighted text is utilized to substantiate the data set and to develop a data mining algorithm (300), The highlighted text may be keywords, key phrases or entire sentences, as determined by the expert. With reference to FIGS. 2D-2F, it can be seen that the method and process of the present invention allows a user to input data during an Encounter or review of the record and make it available to the Patient's Data Set (300), in real time, if necessary.

Step 2. Develop a data mining algorithm to automate extraction of the data features using the experts' selection of the desired features (300).

With reference to FIG. 2C, the Medical Record (321) for the patient contains highlighted text (322). This highlighted text (322) comprises the relevant facts which were extracted by experts, and is used as a training data set fir purposes of data extraction automation via intelligent use of regular expressions, sentence parsing, named entity recognition, sentiment analysis, medical term normalisation, and other methods of natural language processing (NLP) and, also, via use of supervised machine learning methods e.g. kernel methods, neural networks, probabilistic modeling etc. as well as semi-supervised approaches, including active learning.

Step 3. Supplement the Patient's Data Set with patient and/or caregiver input (400).

The Patient's Data Set is supplemented with data from surveys from patients, physicians and other care providers (e.g., family members, home health care aides, etc.). In addition, patients may also be able to input data in real time into the dataset (300) via a chatbot type application. The chatbot of the present invention has access to and relies on the Patient's Data Set (300), and it prompts and/or assists the patient in managing behavior for optimal treatment of the disease via disease and patient specific questions and responses.

Step 4. Analyze Patient's Data Set to confirm or update patient course of treatment (500)

The entire Patient's Data Set, which includes surveys, data input, and the medical record, is analyzed in real time, or in managed batches, to either confirm or modify the patient's course of treatment.

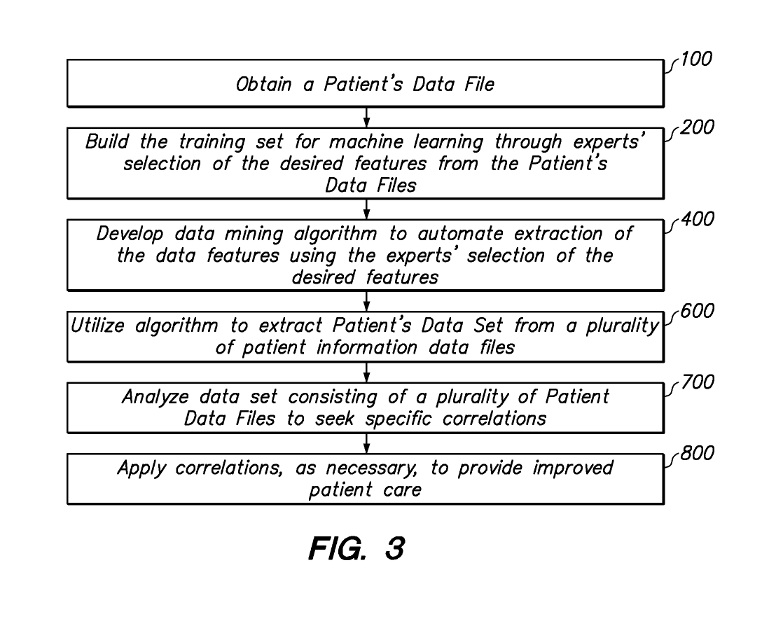

In another embodiment of the present invention, as in FIG. 3, datasets from patients with the same medical diagnoses are used to build a data registry, which may then be used to improve patient care. In use, Steps 1 through 3, above, are repeated for a plurality of patients to generate the data registry. The data registry can be generated by de-identifying the data to build a large, high quality, curated de-identified data set, or built with identifiable data with the informed consent of the patient. The de-identified and fully identified data sets are then analyzed to find patterns and insights that improve patient care. The data registry may be accessed by third parties, who may search the collected data using their own pre-determined search criteria or utilise pre-configured search criteria. All information available ire the data registry able to be accessed by third parties would be in compliance with Federal and State regulations regarding patient consent and care.

The system for implementing the method of the present invention is one that is well known to those within and without the art. This system is comprised of a computer, a smart phone or any other device able to execute the software of the present invention. The computer, smart phone or other device includes a storage device, a central processing unit (CPU) and an interface device. Further, there is included at least one input device which may be comprised of a scanner, a keyboard, a mouse, a cellular phone, voice input, and other external data input devices as are now known or may be developed. Software for execution of the method is stored in the storage device, and is executed on the CPU. Documents and data are acquired by the system and are converted into an electronic file. These electronic files are read by the computer and processed according to the method of the present invention.

While preferred embodiments have been illustrated and described in detail in the drawings and foregoing description, they are to be considered as illustrative and not restrictive in character, it being understood that only the preferred embodiments have been shown and described and that all changes and modifications that come within the spirit of the invention both now or in the future are desired to be protected.

1. A method for building a Patient's Data Set from a Patient's Data File to provide robust patient care, said method comprising the steps of:
obtaining a Patient's Data File;
building a training set for machine learning through experts' selection of at least one desired feature from the Patient's Data File to create the Patient's Data Set;
developing a data mining algorithm to automate extraction of at least one data feature from at least one other Patient's Data File using the training set, said algorithm automatically generating said Patient's Data Set from at least one other Patient's Data File;
supplementing the Patient's Data Set with at least one patient input; and
analyzing the Patient's Data Set to confirm patient course of treatment.

2. The method of claim 1, wherein the Patient's Data Set is analyzed in real time.

3. The method of claim 1, wherein the patient course of treatment is modified based on the analysis of the patient data set.

4. The method of claim 1, wherein the data set is supplemented by a patient's caregiver.

5. The method of claim 1, wherein the patient input is performed by providing data to a chatbot.

6. A system for building a Patient's Data Set from a Patient's Data File to provide robust patient care, said system performing the steps of:
reading a document input from a Patient's Data File;
extracting at least one data feature from said document using a training set, said training set comprised of at least one desired feature from the Patient's Data File, said at least one desired feature being pre-supplied to said application, said extracted data feature comprising a Patient's Data Set; and
analyzing the Patient's Data Set to confirm patient course of treatment.

7. The system of claim 6, wherein the Patient's Data Set is analysed in real time.

8. The system of claim 6, wherein the patent course of treatment is modified based on the analysis of the patient data set.

9. The system of claim 6, wherein the data set is supplemented with at least one patient input.

10. The system of claim 6, wherein the data set is supplemented by at least on caregiver input.

11. The system of claim 9, wherein at least one patient input is provided through the use of an interactive chatbot.

12. A method for optimizing robust patient care, said method comprising the steps of:
obtaining a first Patient's Data File, said patient having a specific medical diagnosis;
building a training set for machine learning through experts' selection of at least one desired feature from the Patient's Data File to create a Patient's Data Set;
developing a data mining algorithm to automate extraction of said at least one data feature using the training set, said algorithm automatically generating said Patient's Data Set;
obtaining at least one other Patient's Data File, said other patient having the same medical diagnosis as the first patient;
using the data mining algorithm to create a Patient's Data Set for said other patient;
analyzing the Patient's Data Set for the first patient and said another patient to seek correlations; and
applying correlations to confirm the patient's course of treatment.

13. The method of claim 12, wherein the correlation is applied to modify patient care.

14. A system for optimizing robust patient care, said system performing the steps of:
obtaining a first Patient's Data File, said patient having a specific medical diagnosis;
obtaining at least one other Patient's Data File, said another patient having the same medical diagnosis as the first patient;
extracting at least one data feature from the Patient's Data File using a training set, said training set comprised of at least one desired feature from the Patient's Data File, said at least one desired feature being pre-supplied to said application, said extracted data feature comprising a Patient's Data Set;
analyzing the Patient's Data Set for the first patient and said other patient to seek correlations; and
applying correlations to confirm the patient's course of treatment.

15. A method for building a data registry, said method comprising the steps of:
obtaining a first Patient's Data File, said patient having a specific medical diagnosis;
building a training set for machine learning through experts' selection of at least one desired feature from the Patient's Data File to create the Patient's Data Set;
developing a data mining algorithm to automate extraction of said at least one data feature using the training set, said algorithm automatically generating said Patient's Data Set;
obtaining at least one other Patient's Data File, said other patient having the same medical diagnosis as the first patient;
using the data mining algorithm to create a Patient's Data Set for said other patient; and
storing the first Patient's Data Set and the other Patient's Data Set in a computer readable medium, wherein said data sets are able to be accessed by a user.

16. A method for providing robust patient care, said method comprising the steps of:
obtaining a Patient's Data Set;
acquiring a patient's self tracking data;
analysing said self tracking data via a pre-determined search criteria;
comparing the results of the said pre-determined search criteria with a Patient's Data Set;
providing the patient with diagnosis specific information based on the analysis of patient's self tracking data.

17. The method of claim 16, wherein said analysis of the patient's self tracking data is conducted in real time.

18. The method of claim 16, wherein the patient is provided with diagnosis specific information in real time based on the analysis of the self tracking data.

19. The method of claim 16, wherein said self provided data is obtained from at least one social media account.

20. The method of claim 16, wherein said self provided data is obtained from at least one health monitoring device.

21. The method of claim 16, wherein said self provided data is obtained from at least one self tracking device.

22. The method of claim 16, wherein said self tracking data provides data about a patient's external environment.
